(19) United States
(12) Patent Application Publication
(10) Pub. No.: US 2008/0320301 A1
(43) Pub. Date: Dec. 25, 2008

(54) METHOD AND APPARATUS FOR RESTRICTING OPERATION OF DEVICE

(75) Inventors: Jun-bum SHIN, Suwon-si (KR); Yang-Iim CHOI, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/123,055

(22) Filed: May 19, 2008

Related U.S. Application Data
(60) Provisional application No. 60/945,160, filed on Jun. 20, 2007.
(60) Provisional application No. 60/945,177, filed on Jun. 20, 2007.

(30) Foreign Application Priority Data
Sep. 27, 2007 (KR) 10-2007-0097381

(51) Int. Cl. H04L 9/00

(52) U.S. Cl. 713/158

(57) ABSTRACT

A method of restricting operation of a device is provided. Based on a revocation list, which is a list regarding revoked devices, the method determines whether the device is the revoked device, based on the determination, decides whether to operate a Digital Rights Management (DRM) module of the device, and based on the decision, selectively restricts the operation of the device.

### CROSS-REFERENCE TO RELATED PATENT APPLICATION

This application claims the benefit of Korean Patent Application No. 10-2007-0097381, filed on Sep. 27, 2007, in the Korean Intellectual Property Office, and the benefit of U.S. provisional Patent Application No, 60/945,160, filed on Jun. 20, 2007, and U.S. Provisional Patent Application No, 60/945,177, filed on Jun. 20, 2007, in the U.S. Patent and Trademark Office, the disclosures of which are incorporated herein in their entirety by reference.

### BACKGROUND OF THE INVENTION

1. Field of the Invention

The present invention relates to a method and apparatus for restricting operation of a device.

2. Description of the Related Art

Due to the widespread use of computers, game consoles, portable devices, and the like, the necessity for protecting content used in the aforementioned devices has been raised.

Thus, many companies are developing a Digital Rights Management (DRM) technology for preventing content from being illegally copied and altered.

However, there exists a method of hacking the aforementioned devices so as to remove protection of the content protected by DRM technology, and thereby release the content so as to be used without limitation, and thus, a method of restricting operation of such hacked devices has also been provided.

For example, an Advanced Access Content System License Administrator (AACS LA) prevents content, in which encryption by AACS is unprotected, from being reproduced in hacked devices, and in the case where a device of another communicating party has been hacked, Digital Transmission Content Protection (DTCP) forbids content to be transmitted to the hacked device of the other communicating party.

Also, in the case of ‘XBOX’, which is a game console produced by Microsoft Corporation, when XBOX connects to a network, if the connected XBOX is determined to be a hacked device, the hacked XBOX is thereafter prevented from connecting to the network. By doing so, a user of the hacked XBOX cannot play an online game.

However, the aforementioned methods of protecting content have problems since the methods cannot efficiently restrict content that is accessed by using hacked devices.

### SUMMARY OF THE INVENTION

The present invention provides a method and apparatus for restricting operation of a device, so as to efficiently restrict usage of contents in a revoked device.

According to an aspect of the present invention, there is provided a method of restricting operation of a device, the method including the operations of determining whether the device is a revoked device, based on a revocation list that is a list regarding revoked devices; deciding whether to operate a Digital Rights Management (DRM) module of the device, based on the determination; and selectively restricting the operation of the device, based on the decision.

The method may further include the operation of updating the revocation list, wherein, when a firmware update of the device is performed, the operation of updating the revocation list includes the operation of updating the revocation list by using a revocation list received together with data which is received so as to perform the firmware update.

The method may further include the operation of updating the revocation list, wherein, when the device receives content, the operation of updating the revocation list includes the operation of updating the revocation list by using a revocation list received together with the content, as additional information of the content.

The determining of whether the device is revoked may include the operation of performing the determination based on whether at least one of an identification (ID), a serial number, and a production number, which are respectively related to the device, exists in the revocation list.

The revocation list may be comprised of at least one of an ID, a serial number, and a production number, which are respectively related to revoked devices, or at least one of hash values of each of the ID, the serial number, and the production number, which are respectively related to the revoked devices.

The operation of determining whether the device is revoked may include the operation of performing the determination based on a revocation list stored in the device.

The operation of determining whether the device is revoked may include the operations of requesting a server storing the revocation list to determine whether the device is revoked; and receiving a result of the determination from the server, wherein the determination is related to whether the device is revoked.

The method may further include the operation of receiving the revocation list, wherein the operation of determining whether the device is revoked includes the operation of performing the determination based on a received revocation list.

According to another aspect of the present invention, there is provided an operation restriction apparatus installed in a device so as to restrict operation of the device, the operation restriction apparatus including a revocation determination unit determining whether the device is a revoked device, based on a revocation list that is a list regarding revoked devices; a DRM module operation decision unit deciding whether to operate a DRM module of the device, based on the determination; and an operation restriction unit selectively restricting the operation of the device, based on the decision of the DRM module operation decision unit.

The revocation determination unit may include a determination request unit requesting a server storing the revocation list to determine whether the device is revoked; and a determination receiving unit receiving a result of the determination from the server, wherein the determination is related to whether the device is revoked.

The operation restriction apparatus may further include a receiving unit receiving the revocation list, wherein the revocation determination unit performs the determination based on the received revocation list.

The operation restriction apparatus may further include an update unit updating the revocation list, wherein, when the receiving unit receives data for updating firmware of the device, the update unit updates the revocation list by using a revocation list received together with the data.

The operation restriction apparatus may further include an update unit updating the revocation list, wherein, when the receiving unit receives content, the update unit updates the revocation list by using a revocation list received together with the content, as additional information of the content.

According to another aspect of the present invention, there is provided a computer readable recording medium having recorded thereon a program for executing a method of restricting operation of a device, the method including the operations of determining whether the device is a revoked device, based on a revocation list that is a list regarding revoked devices; deciding whether to operate a DRM (Digital Rights Management) module of the device, based on the determination; and selectively restricting the operation of the device, based on the decision.

### BRIEF DESCRIPTION OF THE DRAWINGS

The above and other features of the present invention will become more apparent by describing in detail exemplary embodiments thereof with reference to the attached drawings in which:

FIG. 1 is a block diagram illustrating an operation restriction apparatus for restricting operation of a device, according to an embodiment of the present invention;

FIG. 2 is a flowchart illustrating a method of restricting operation of a device, according to an embodiment of the present invention;

FIG. 3 is a flowchart illustrating a method of restricting operation of a device, according to another embodiment of the present invention; and

FIG. 4 is a flowchart illustrating a method of restricting operation of a device, according to another embodiment of the present invention.

### DETAILED DESCRIPTION OF THE INVENTION

The present invention will now be described more fully with reference to the accompanying drawings, in which exemplary embodiments of the invention are shown.

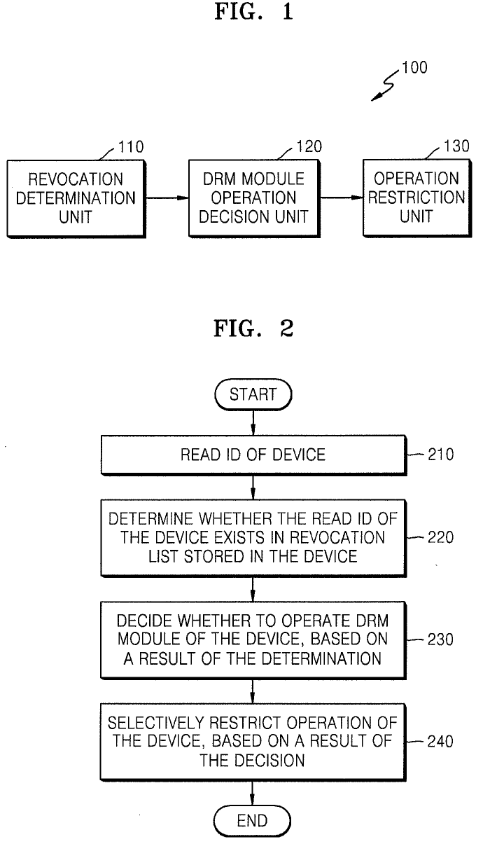

FIG. 1 is a block diagram illustrating an operation restriction apparatus 100 for restricting operation of a device, according to an embodiment of the present invention.

Referring to FIG. 1, the operation restriction apparatus 100 for restricting operation of the device, according to the present invention, includes a revocation determination unit 110, a Digital Rights Management (DRM) module operation decision unit 120, and an operation restriction unit 130.

Based on a revocation list, which is a list regarding revoked devices, i.e., a list of revoked devices, the revocation determination unit 110 determines whether a device is the revoked device.

Here, the revocation list may be comprised of at least one of an identification (ID), a serial number, and a production number which are respectively related to the revoked devices, or at least one of hash values of each of the ID, the serial number, and the production number. Here, the revoked device corresponds to a device which is determined to be a hacked device.

The revocation list may not be limited to the values that are described above but may include all identifiers which are capable of recognizing the revoked device and which are related to the revoked device.

At this time, the revocation determination unit 110 may determine that a device has been revoked, based on whether at least one of an ID, a serial number, and a production number which are respectively related to the device is included in the revocation list. For example, when the ID of the device is included in the revocation list, the revocation determination unit 110 determines that the device is revoked. Also, when a hash value related to the ID of the device is included in the revocation list, the revocation determination unit 110 determines that the device is revoked.

Meanwhile, the revocation determination unit 110 may receive a revocation list from outside of the device, and determine that the device has been revoked, based on the received revocation list, or determine that the device has been revoked, based on a revocation list stored in the device.

The operation restriction apparatus 100 for restricting operation of the device, according to the present invention, may further include a receiving unit (not shown) for receiving a revocation list.

In the case where revocation of the device is determined based on the revocation list stored in the device, the revocation determination unit 110 may update the revocation list by using the revocation list received by the receiving unit.

For example, when a device is initially manufactured and a revocation list is stored therein, the device may regularly or irregularly update the revocation list stored in the device, and determine whether the device has been revoked. The update of the revocation list may be performed by using one of the two methods described below.

When a device receives data for updating firmware of the device, there is a first method by which the device updates a revocation list of the data by using a revocation list received together with the data.

That is, when a user need to update firmware of a device, the user connects the device to a personal computer (PC), or the like so as to receive data for updating the firmware. At this time, a revocation list is received together with the data, thereby updating a revocation list of the device to a latest revocation list, whenever updating of the firmware is performed. However, when the revocation list received together with the data for updating the firmware is not later than the revocation list stored in the device, updating of the revocation list is not performed.

Next, when a device receives content, there is a second method by which updating is performed by using a revocation list, received together with the content, as additional information of the content.

For example, when the device receives a broadcasting program as the content, the device may also receive a revocation list as additional information of the content, and updates by using the received revocation list. This second method of receiving content is more often used, compared to the first method of receiving the data for updating the firmware. Thus, in general, the case in which a revocation list is updated by using the second method is much more often used than in the case of the first method. At this time, as described above, when the revocation list received together with the content is not later than the revocation list stored in the device, updating of the revocation list is not performed.

A method of updating a revocation list is not limited to the above mentioned two methods but may also include any method which is capable of regularly or irregularly updating a revocation list stored in a device.

The operation restriction apparatus 100 for restricting operation of the device, according to the present invention, may further include an update unit (not shown) for updating a revocation list stored in a device by using a revocation list received by the receiving unit.

The DRM module operation decision unit 120 decides whether to operate a DRM module of a device, based on the determination of the revocation determination unit 110.

To be more specific, as a result of the determination by the revocation determination unit 110, when the device is determined to have been revoked, the DRM module operation decision unit 120 controls the DRM module so as to be not operated. However, when the device is determined not to have been revoked, the DRM module operation decision unit 120 controls the DRM module to be operated.

Here, the DRM module of the device is for protecting contents, and may be specified by digital rights management solutions used by the DRM module. Examples of such digital rights management solutions are ‘SmartRight’ provided by Thomson Corporation, ‘Open Conditional Content Access Management (OCCAM)’ provided by Cisco Systems, Inc, ‘xCP Cluster Protocol’ provided by IBM, ‘Digital Transmission Content Protection (DTCP)’ provided by Digital Transmission Licensing Administrator (DTLA), and the like. The DRM module according to the present invention corresponds to not only the aforementioned digital rights management solutions but also all solutions which perform i) device rights management, ii) contents rights management, and iii) rights unprotection management. The DRM module may be embodied as not only an application program but also as hardware.

In this manner, the present invention determines, before operation of the DRM module, whether the device has been revoked, decides whether to operate the DRM module, and based on the decision, selectively restricts operation of the device by using the operation restriction unit 130 that will be described later. Thus, the present invention is more efficient than a conventional technology which determines revocation whenever each item of content is reproduced, in the case where a plurality of items of content are reproduced.

Based on the decision of the DRM module operation decision unit 120, the operation restriction unit 130 selectively restricts operation of the device.

At this time, the operation of the device includes reproduction of content, connection to a network, execution of applications, etc. When the DRM module is not operated according to the decision of the DRM module operation decision unit 120, the operation restriction unit 130 restricts the operation of the device.

On the other hand, when the DRM module is operated according to the decision of the DRM module operation decision unit 120, the operation of the device including reproduction of content, connection to a network, execution of applications, etc. are performed in circumstances in which the DRM module is operated.

In this manner, the operation restriction apparatus 100 for restricting operation of the device, according to the present invention, is operated by a process performed in a device, which decides whether to operate the DRM module according to whether the device has been revoked, and as a result of the decision, selectively restricts operation of the device.

FIG. 2 is a flowchart illustrating a method of restricting operation of a device, according to an embodiment of the present invention.

In operation 210, an ID of the device is read.

In operation 220, it is determined whether the read ID of the device exists in a revocation list stored in the device.

At this time, the revocation list stored in the device is regularly or irregularly updated.

Meanwhile, according to embodiments of the present invention, in operation 220, one of a serial number of the device and a production number of the device may be determined to exist in the revocation list.

In operation 230, based on a result of the determination, it is decided whether to operate a DRM module of the device.

In operation 240, based on a result of the decision, operation of the device is selectively restricted.

At this time, only in the case where the DRM module is operated based on the determination related to the operation of the DRM module, the operation of the device is performed.

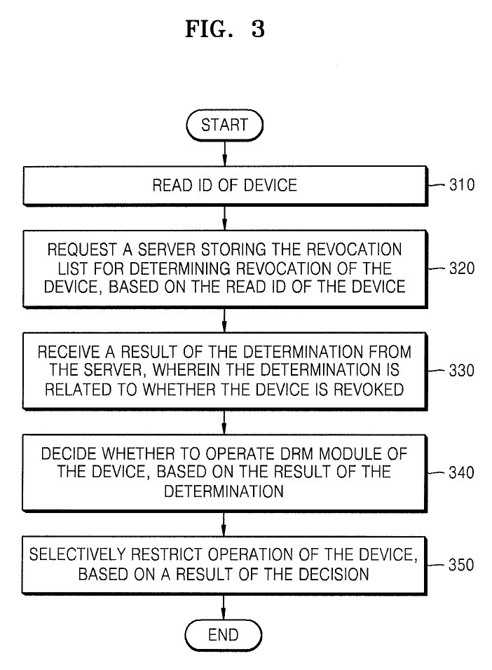

FIG. 3 is a flowchart illustrating a method of restricting operation of a device, according to another embodiment of the present invention.

In operation 310, an ID of the device is read.

In operation 320, based on the read ID of the device, a server storing a revocation list is requested determine whether the device has been revoked.

That is, when the ID of the device is transmitted to the server, the server is requested to determine whether the ID of the device exists in the revocation list stored in the server.

In operation 330, a result of the determination regarding the revocation of the device is received from the server.

At this time, if the ID of the device exists in the revocation list stored in the server, the server determines that the device is revoked, and thereby transmits the result of the determination to the device.

In this manner, unlike the method of restricting the operation of the device according to the previous embodiment which determines whether a device has been revoked, by using a revocation list stored in the device, the method of restricting the operation of the device according to the current embodiment requests the server to determine whether the device has been revoked. Thus, a revocation list does not need to be stored in the device, and the revocation list does not need to be updated.

The revocation determination unit 110 according to the present invention may further include a determination request unit (not shown) for requesting the server storing the revocation list to perform the determination regarding the revocation of the device, and a determination receiving unit (not shown) for receiving a result of the determination regarding the revocation of the device from the server.

In operation 340, based on the result of the determination, it is decided whether to operate a DRM module of the device.

In operation 350, based on a result of the decision, operation of the device is selectively restricted.

In the current embodiment, in the case where the device is a game console, if the device is determined to have been revoked, connecting to a network and playing an online game by using the revoked device may be prohibited. Also, playing an offline game at home without connecting to the network may be prohibited. That is, according to embodiments of the present invention, it may be possible to prohibit only online games, or both online and offline games.

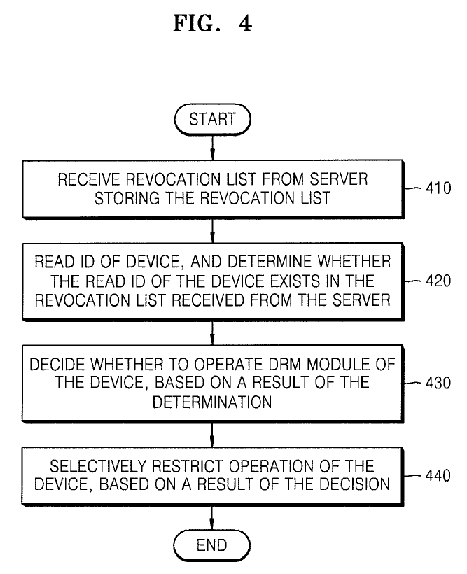

FIG. 4 is a flowchart illustrating a method of restricting operation of a device, according to another embodiment of the present invention.

In operation 410, a revocation list is received from a server storing the revocation list.

In operation 420, an ID of a device is read, and it is determined whether the read ID of the device exists in the revocation list received from the server.

When power is applied to the device, the method of restricting operation of the device, according to the current embodiment of the present invention, first connects to the server so as to receive the revocation list, and based on the received revocation list, determines whether the device has been revoked. Thus, the method does not require a separate procedure for updating a revocation list.

In the case of using the method of restricting the operation of the device according to the current embodiment of the present invention, whenever power is applied to the device, the device connects to the server and receives the revocation list. Thus, the method is advantageous since it is possible to always determine whether the device has been revoked, by using the latest revocation list.

In operation 430, based on a result of the determination, it is decided whether to operate a DRM module of the device.

In operation 440, based on a result of the decision, operation of the device is selectively restricted.

Based on a revocation list, which is a list regarding a revoked device, the present invention determines whether a device is the revoked device, based on the determination, decides whether to operate a DRM module of the device, and based on the decision, selectively restricts operation of the device. By doing so, compared to the conventional technology which determines revocation whenever each item of content is used in the case where a plurality of items of content are used, the present invention can efficiently restrict usage of content in the revoked device, and thus, can reduce a load that is applied to the device.

Also, a revocation list is updated by using a revocation list that is received together with data received so as to perform a firmware update when the firmware update of the device is performed, or by using a revocation list that is received together with content, as additional information of the content, when the device receives the content. Thus, although users do not perform a separate operation for performing an update, the revocation list of the device can be maintained according to the latest information.

The embodiments of the present invention can be written as computer programs and can be implemented in general-use digital computers that execute the programs using a computer readable recording medium.

Examples of the computer readable recording medium include magnetic storage media (e.g., ROM, floppy disks, hard disks, etc.), and optical recording media (e.g., CD-ROMs, or DVDs). Other storage media may include carrier waves (e.g., transmission through the Internet).

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of restricting an operation of a device, the method comprising:
determining whether the device is one of revoked devices, based on a revocation list including a list of the revoked devices, in a determination;
deciding whether to operate a Digital Rights Management (DRM) module of the device, based on the determination, to generate a decision; and
selectively restricting the operation of the device, based on the decision.

2. The method of claim 1, further comprising updating the revocation list,
wherein, if a firmware update of the device is performed, the updating of the revocation list comprises updating the revocation list by using information used to perform the firmware update, the information comprising another revocation list and data.

3. The method of claim 1, further comprising updating the revocation list,
wherein, if the device receives content, the updating of the revocation list comprises updating the revocation list by using a revocation list received together with the content, as additional information of the content.

4. The method of claim 1, wherein the determining of whether the device is one of the revoked devices comprises performing the determination based on whether at least one of an identification (ID) of the device, a serial number of the device, and a production number of the device, exists in the revocation list.

5. The method of claim 1, wherein the revocation list comprises at least one of identifications (IDs) of the revoked devices, serial numbers of the revoked devices, and production numbers of the revoked devices, or at least one of hash values of each of the IDs of the revoked devices, hash values of the serial numbers of the revoked devices, and hash values of the production numbers of the revoked devices.

6. The method of claim 1, wherein the determining of whether the device is one of the revoked devices comprises performing the determination based on the revocation list stored in the device.

7. The method of claim 1, wherein the determining of whether the device is one of the revoked devices comprises:
requesting a server storing the revocation list to determine whether the device is one of the revoked devices; and
receiving a result of the determination from the server, wherein the determination is related to whether the device is one of the revoked devices.

8. The method of claim 1, further comprising receiving the revocation list,
wherein the determining of whether the device is one of the revoked devices comprises performing the determination based on the received revocation list.

9. An apparatus installed in a device to restrict an operation of the device, the apparatus comprising:
a revocation determination unit which determines whether the device is one of revoked devices, based on a revocation list including a list of the revoked devices, in a determination;
a Digital Rights Management (DRM) module operation decision unit which decides whether to operate a DRM module of the device, based on the determination, to generate a decision; and
an operation restriction unit which selectively restricts the operation of the device, based on the decision of the DRM module operation decision unit.

10. The apparatus of claim 9, further comprising a receiving unit which receives the revocation list,
wherein the revocation determination unit performs the determination based on the received revocation list.

11. The apparatus of claim 10, further comprising an update unit which updates the revocation list,
wherein, if the receiving unit receives data for updating a firmware of the device, the update unit updates the revocation list by using a revocation list received together with information used to update the firmware, the information comprising another revocation list and data.

12. The apparatus of claim 10, further comprising an update unit which updates the revocation list,
wherein, if the receiving unit receives content, the update unit updates the revocation list by using a revocation list received together with the content, as additional information of the content.

13. The apparatus of claim 9, wherein the revocation determination unit performs the determination based on whether at least one of an identification (ID) of the device, a serial number of the device, and a production number of the device exists in the revocation list.

14. The apparatus of claim 9, wherein the revocation list comprises at least one of identifications (IDs) of the revoked devices, serial numbers of the revoked devices, and production numbers of the revoked devices, or at least one of hash values of each of the IDs of the revoked devices, hash values of the serial numbers of the revoked devices, and hash values of the production numbers of the revoked devices.

15. The apparatus of claim 9, wherein the revocation determination unit performs the determination based on the revocation list stored in the device.

16. The apparatus of claim 9, wherein the revocation determination unit comprises:
a determination request unit which requests a server storing the revocation list to determine whether the device is one of the revoked devices; and
a determination receiving unit which receives a result of a determination from the server, wherein the determination from the server is related to whether the device is one of the revoked devices.

17. A computer readable recording medium having recorded thereon a program for executing the method of comprising:
determining whether the device is one of revoked devices, based on a revocation list including a list of the revoked devices, in a determination;
deciding whether to operate a Digital Rights Management (DRM) module of the device, based on the determination, to generate a decision; and
selectively restricting the operation of the device, based on the decision.
